(19) United States
(12) Patent Application Publication
(10) Pub. No.: US 2025/0004122 A1
(43) Pub. Date: Jan. 2, 2025

(54) WIRELESS BASED PRESENCE DETECTION

(71) Applicant: Samsung Electronics Co., Ltd., Suwon-si (KR)

(72) Inventors: Songwei Li, Plano, TX (US); Guanbo Chen, Plano, TX (US); Yuming Zhu, Plano, TX (US); Vishnu Vardhan Ratnam, Frisco, TX (US); Viet Nguyen, Frisco, TX (US)

(21) Appl. No.: 18/752,605

(22) Filed: Jun. 24, 2024

Related U.S. Application Data
(60) Provisional application No. 63/524,505, filed on Jun. 30, 2023.
(60) Provisional application No. 63/541,732, filed on Sep. 29, 2023.
(60) Provisional application No. 63/623,578, filed on Jan. 22, 2024.

(51) Int. Cl. G01S 13/56; G01S 7/00; G01S 7/41; G01S 13/00

(52) U.S. Cl. CPC G01S 13/56; G01S 7/006; G01S 7/415; G01S 13/003

(57) ABSTRACT

One embodiment provides a method for presence detection based on wireless signal analysis, the method comprising extracting features from wireless signals transmitted between a plurality of stations (STAs) and at least one access-point (AP) located within a space comprising a plurality of portions, wherein the AP is located in a particular portion of the space and a plurality of STAs are located in different portions in the space such that there are non-line-of-sight (NLOS) signals between the AP and the plurality of STAs as a result of signal obstructions within the space, processing the features using feature analysis, and detecting a location of a user motion within a particular portion of the plurality of portions of the space based on the feature analysis.

### CROSS-REFERENCE TO RELATED APPLICATIONS

This application claims the benefit of priority from U.S. Provisional Application No. 63/524,505, entitled “Statistical Features for WiFi-Based Presence Detection” filed Jun. 30, 2023, U.S. Provisional Application No. 63/541,732, entitled “Statistical Features for WiFi-Based Presence Detection” filed Sep. 29, 2023, and U.S. Provisional Application No. 63/623,578, entitled “Statistical Features for WiFi-Based Presence Detection” filed Jan. 22, 2024, all of which are incorporated herein by reference in their entireties.

### TECHNICAL FIELD

This disclosure relates generally to a wireless communication system, and more particularly to, for example, but not limited to, wireless based presence detection.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a method for presence detection based on wireless signal analysis. The method includes extracting features from wireless signals transmitted between a plurality of stations (STAs) and at least one access-point (AP) located within an indoor space comprising a plurality of portions, wherein the AP is located in a particular portion of the space and a plurality of STAs are located in different portions in the space such that there are non-line-of-sight (NLOS) signals between the AP and the plurality of STAs as a result of signal obstructions within the space and there is at least one STA in the same portion as the AP to provide a line-of-sign (LOS) signals with the AP. The method includes processing the features using feature analysis to determine NLOS and LOS conditions of the space. The method includes detecting a location of a user motion within a particular portion of the plurality of portions of the space based on the feature analysis.

In some embodiments, the features are extracted from channel state information, received signal strength (RSS), or timing information of the wireless signals.

In some embodiments, the method further includes computing skewness that describes a difference between obstructed and unobstructed wireless signals to detect the location of the user motion.

In some embodiments, the method further includes comprising computing variance of distance by round-trip-time (RTT) of the wireless signals to detect the location of the user motion.

In some embodiments, the method further includes computing variance of received signal strength indicator (RSSI) of the wireless signals to detect the location of the user motion.

In some embodiments, the method further includes computing a median standard deviation (STD) of channel state information (CSI) difference between two antennas to detect the location of the user motion.

In some embodiments, the method further includes computing statistical features of received signal strength indicators (RSSIs) of the wireless signals including at least one of variance of RSSI or standard deviation (STD) of RSSI difference to detect the location of the user motion.

In some embodiments, the method further includes extracting features from signal amplitude and phase difference from the wireless signals, and reducing the features for motion detection models to detect the location of the user motion.

In some embodiments, the method further includes monitoring the plurality of portions of the space without motion for a period of time to compute noise backgrounds for the plurality of portions, and detecting the location of the user motion based on a comparison with the noise background for the plurality of portions.

In some embodiments, the method further includes using machine learning to process the features to detect the location of the user motion, using a state machine to decide the real location of the user motion and reduce a false prediction caused by interference of motion in adjacent rooms, or using a motion model trained by a graph neural network to detect the location of the user motion.

In some embodiments, the method further includes using features from multiple links between the plurality of STAs and the AP to detect the location of the user motion.

One aspect of the present disclosure provides a station (STA) in a wireless network. The STA comprises a memory and a processor coupled to the memory. The processor is configured to extract features from wireless signals transmitted between a plurality of stations (STAs) and at least one access-point (AP) located within an indoor space comprising a plurality of portions, wherein the AP is located in a particular portion of the space and a plurality of STAs are located in different portions in the space such that there are non-line-of-sight (NLOS) wireless signals between the AP and the plurality of STAs as a result of signal obstructions within the space and there is at least one STA in the same portion of the space as the AP to provide line-of-sight (LOS) wireless signals with the AP. The processor is configured to process the features using feature analysis to determine NLOS and LOS conditions of the space. The processor is configured to detect a location of a user motion within a particular portion of the plurality of portions of the space based on the feature analysis.

In some embodiments, the features are extracted from channel state information, received signal strength (RSS), or timing information of the wireless signals.

In some embodiments, the processor is further configured to compute skewness that describes a difference between obstructed and unobstructed wireless signals to detect the location of the user motion.

In some embodiments, the processor is further configured to compute variance of distance by round-trip-time (RTT) of the wireless signals to detect the location of the user motion.

In some embodiments, the processor is further configured to compute variance of received signal strength indicator (RSSI) of the wireless signals to detect the location of the user motion.

In some embodiments, the processor is further configured to compute a median standard deviation (STD) of channel state information (CSI) difference between two antennas to detect the location of the user motion.

In some embodiments, the processor is further configured to compute statistical features of received signal strength indicators (RSSIs) of the wireless signals including at least one of variance of RSSI or standard deviation (STD) of RSSI difference to detect the location of the user motion.

In some embodiments, the processor is further configured to extract features from signal amplitude and phase difference from the wireless signals, and reduce the features for motion detection models to detect the location of the user motion.

In some embodiments, the processor is further configured to monitor the plurality of portions of the space without motion for a period of time to compute noise background for the plurality of portions, and detect the location of the user motion based on a comparison with the noise background for the plurality of portions.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates a process of computing a variance of phase differences in accordance with an embodiment.

FIG. 4A illustrates a process of computing a median of variances of phase differences in accordance with an embodiment.

FIG. 4B illustrates phase difference with and without Hampel filter in accordance with an embodiment.

FIG. 5 illustrates an example process of computing kurtosis of frequency-weighted channel state information (CSI) in accordance with an embodiment.

FIG. 6 illustrates Kurtosis of a device's (CSI in line-of-sight (LOS) and non line-of-sight (NLOS) in accordance with an embodiment.

FIG. 7 illustrates an example process of extracting skewness of channel impulse response (CIR) in accordance with an embodiment.

FIG. 8 shows the difference in the skewness of LOS/NLOS in one experiment in accordance with an embodiment.

FIG. 9 shows the different pattern of round trip time (RTT) and received signal strength indicator (RSSI) variance in one experiment in accordance with an embodiment.

FIG. 10 illustrates an example process to compute the variance or median of all subcarriers' CSI variance in a sliding window in accordance with an embodiment.

FIG. 11 shows the variance of all subcarriers' CSI variances in a room with motion that has larger values compared with variances in a room without motion in accordance with an embodiment.

FIG. 12 illustrates an example process of determining a median standard deviation (STD) of CSI difference in accordance with an embodiment.

FIG. 13 illustrates a process for determining a maximum variance of CSI in accordance with an embodiment.

FIG. 14 illustrates a process for determining a maximum median of CSI in accordance with an embodiment.

FIG. 15 illustrates a process for determining a variance of CSI difference STD between two devices in accordance with an embodiment.

FIG. 16 illustrates computing phase difference in accordance with an embodiment.

FIG. 17 illustrates graphs with the CSI STD information for motion cases and empty cases in an experiment in accordance with an embodiment.

FIG. 18 illustrates a phase difference of some subcarriers between two antennas in accordance with an embodiment.

FIG. 19 illustrates RSSI variances with and without motion in accordance with an embodiment.

FIG. 20 illustrates an example process of computing STD of RSSI difference in accordance with an embodiment.

FIG. 21 illustrates a process of feature extraction using principal component analyses (PCA) to analyze CSI in accordance with an embodiment.

FIG. 22 illustrates an example of multi-links between devices and an access point (AP) in accordance with an embodiment.

FIG. 23 illustrates an example flow chart of a process for presence detection based on a threshold method in accordance with an embodiment.

FIG. 24 illustrates a process of presence detection based on machine learning and deep learning in accordance with an embodiment.

FIG. 25 illustrates a CNN model for presence detection for one room in accordance with an embodiment.

FIG. 26 illustrates a long short-term memory network (LSTM) method for motion detection in accordance with an embodiment.

FIG. 27 illustrates a process of LSTM in accordance with an embodiment.

FIG. 28 illustrates a built GNN model in accordance with an embodiment.

FIG. 29 illustrates a building with four rooms and an AP positioned in a particular room in accordance with an embodiment.

FIG. 30 illustrates a reference test setup in accordance with an embodiment.

FIG. 31 illustrates a reference test setup in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

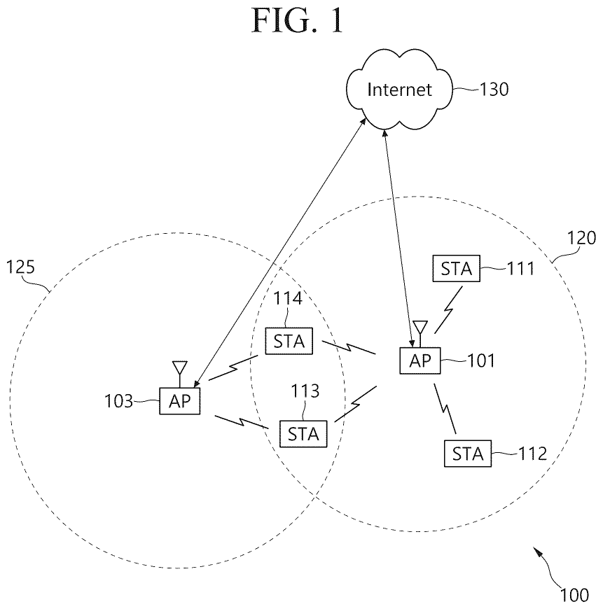

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

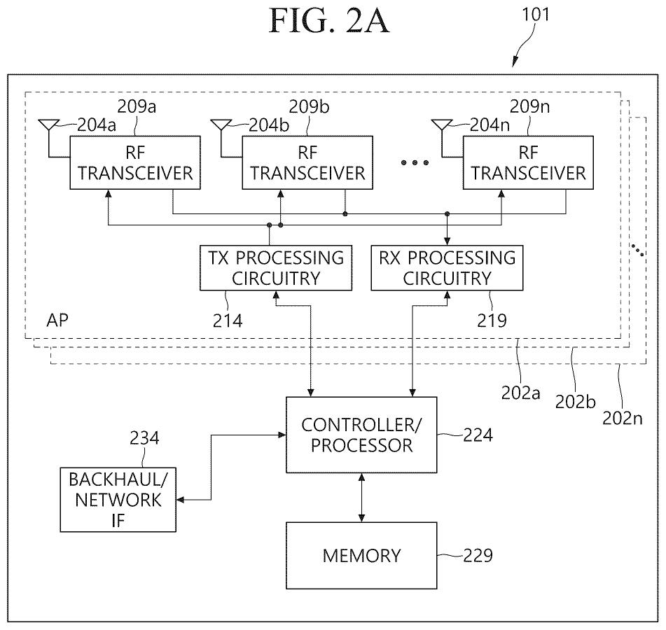

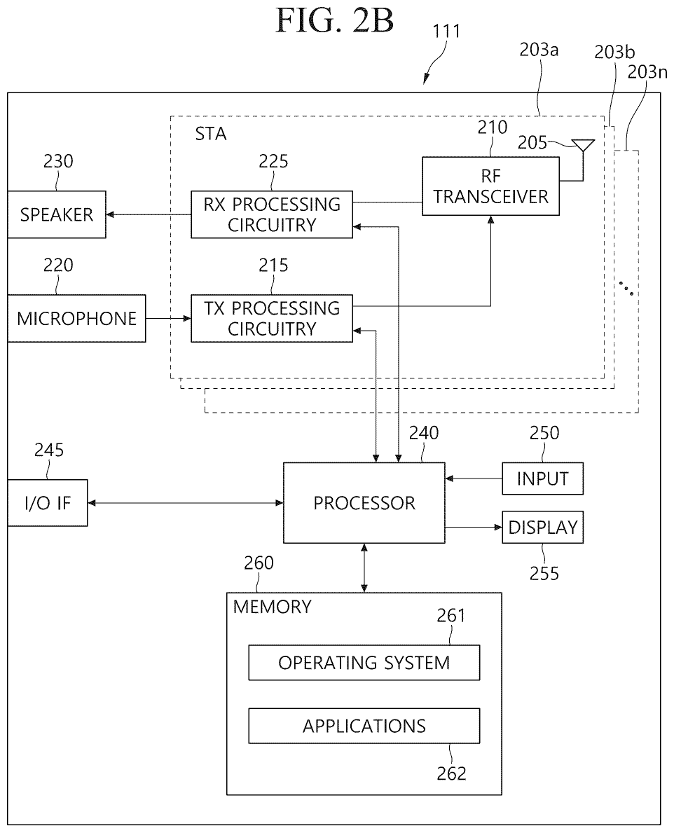

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

Most appliances have been embodied Wi-Fi adapters, such as TVs, dishwashers, washer and dryer, which can provide a smart home environment. Wi-Fi adapters may also be deployed on small devices such as wireless chargers, vacuum robots and portable devices. These devices may connect with Wi-Fi extenders and Wi-Fi routers (AP). In some embodiments, these devices may provide the ability to determine proximity and presence detection based on Wi-Fi channel state information and/or channel impulse response (CSI/CIR) information. In particular, motion generated by walking around these devices can disturb the CSI/CIR in the environment and the disturbance may create different patterns that can be useful in distinguishing between moving and static environments. This information may be used detect, for example, whether a user is moving closer to or farther away from a device. In some embodiments, proximity and presence detection based on Wi-Fi CSI/CIR may be applied on the smart home for various functionalities. For example, proximity detection can be used to display the battery level when a user walks towards a phone charging on a wireless charger hub. Proximity detection can be used to turn on and off the display on a refrigerator when a user walks close to or far away from the refrigerator. Presence detection can be used to turn off a TV when no user is detected in the room, among various other functionalities.

However, reliable and precise results in Wi-Fi-based applications may face challenges such as identifying the Line-of-Sight (LOS) or Non-Line-of-Sight (NLOS) environments and feature extraction from wireless channels. Feature extraction may be important for identifying LOS/NLOS and motion detection for presence detection with statistical thresholds and/or machine learning algorithms.

To differentiate between line-of-sight (LOS)/Non-line-of-sight (NLOS) scenarios and motion detection, simply using raw Wi-Fi data like Channel State Information (CSI), Wi-Fi Received Signal Strength (RSS), or Wi-Fi Round-Trip Time (RTT) may not be feasible due to Wi-Fi device bandwidth limitations. To achieve accurate LOS/NLOS identification and motion detection, extracted statistical features with different patterns in LOS/NLOS and moving versus static cases may be key to successful identification. Furthermore, the manner by which such features are extracted from CSI, RSSI, and RTT data may play an important role in determining the accuracy of the identification process.

Some embodiments may extract features from CSI, Channel Impulse Response (CIR), RTT or RSSI, among others. When there are multiple devices and APs in different rooms, motion can disturb CSI/CIR patterns of multiple devices, making it difficult to do presence detection according to CSI/CIR between one device and one AP.

Challenges for presence detection based on Wi-Fi CSI/CIR may include differentiating between moving and static cases based on Wi-Fi CSI/CIR. Other challenges may include deciding which room detects motion when using multiple links between devices and Wi-Fi APs.

In some embodiments, channel state information (CSI) characterizes a wireless channel's properties for a signal propagating from transmitter to receiver. CSI may include amplitude and phase angle and can be described by the following formula:

$$H ( {f}_{k} , t ) = \vert H ( {f}_{k} , t ) \vert \cdot {e}^{j ∠H ( {f}_{k} , t )} \qquad ( 1 )$$

where the |H(fₖ, t)| represents the amplitude of the k^{th} subcarrier and ∠H(fₖ, t) represents its phase. Statistical features could be extracted from amplitudes and phases of CSI separately.

Some embodiments may determine a channel impulse response (CIR). CIR can be converted by CSI using inverse fast Fourier transform. Meanwhile, the signal changes from a frequency domain to a time domain. The CIR can be described as:

$$h ( t ) = {\sum }_{i}^{N} {a}_{i} δ ( τ - {τ}_{i} ) \qquad ( 2 )$$

where N is the number of paths, aᵢ is the power attenuation, and τᵢ denotes the delay of the i^{th} path. In an ideal case, CIR in LOS has a smaller delay spread and a more robust and more stable energy peak than ones in the NLOS.

Described are various features for LOS/NLSOS detection. Some embodiments may determine the variance of phase differences (phase_diff). In particular, wireless routers may have multiple antennas. One signal may arrive to each antenna at a different time which causes phase angles received by antennas different.

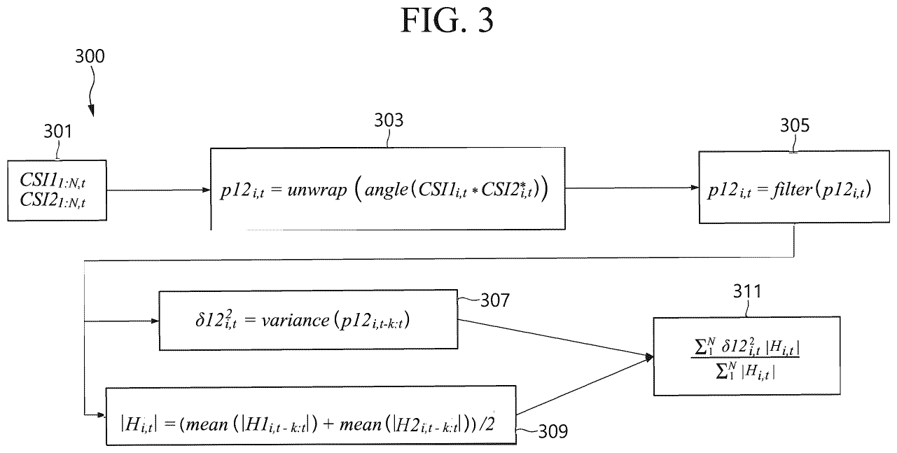

FIG. 3 illustrates an example process of computing a variance of phase difference at a time t in accordance with an embodiment. The process 300 to calculate the variance of phase difference at time t in accordance with an embodiment are set forth below. In particular, to calculate the variance of phase difference between two antennas (CSI1ₜ, CSI2ₜ) at time t and subcarrier i. Every CSI has N subcarriers. N could be all subcarriers, part number of subcarriers, or select subcarriers with the largest amplitudes. After calculating phase difference p12_{i,t} at time t, and subcarrier i, the process 300 may smooth the phase difference with a filter, such as Hampel filter and DBSCAN among others, to remove the abnormal data. The process may then calculate the variance of phase difference δ12_{i,t}² and amplitude |H_{i,t}| within a sliding window from time t−k to time t. The amplitude |H_{i,t}| of subcarrier i at time t is the mean of CSI1_{i,t} amplitude and CSI2_{i,t} amplitude. Finally, the phase feature may be obtained using the sum of all variances of phase difference and weighted by their amplitudes.

In particular, in step 301, the process obtains channel state information:

$$CSI {1}_{1 : N , t} CSI {2}_{1 : N , t} \qquad ( 3 a )$$

At step 303, the process computes phase difference p12_{i,t} at time t, and subcarrier i:

$$p 1 {2}_{i , t} = unwrap ( angle ( CS {1}_{i , t} * CS {2}_{i , t )}^{*} ) \qquad ( 3 b )$$

At step 305, the process smooths the phase difference with a filter to remove abnormal data by:

$$p {12}_{i , t} = filter ( p 1 {2}_{i , t} ) \qquad ( 4 )$$

The output of step 305 is provided to steps 307 and 309.

In step 307, the process computes the phase difference δ12_{i,t}² within a sliding window from time t−k to time t:

$$δ 1 {2}_{i , t}^{2} = variance ( p {12}_{i , t - k : t} ) \qquad ( 5 )$$

In step 309, the process computes the amplitude |H_{i,t}| within a sliding window from time t−k to time t:

$$\vert {H}_{i , t} \vert = \frac{mean ( \vert H {1}_{i , t - k : t} \vert ) + mean ( \vert H {2}_{i , t - k : t} \vert )}{2} \qquad ( 6 )$$

The amplitude |H_{i,t}| of subcarrier i at time t is the mean of CSI1_{i,t} amplitude and CSI2_{i,t} amplitude.

In step 311, the process obtains the phase feature using the sum of all variances of phase difference and weighted by their amplitudes:

$$\frac{{\sum }_{1}^{N} {δ12}_{i , t}^{2} \vert {H}_{i , t} \vert}{{\sum }_{1}^{N} \vert {H}_{i , t} \vert} \qquad ( 7 )$$

Some embodiments may use the median of variances of phase differences as described below.

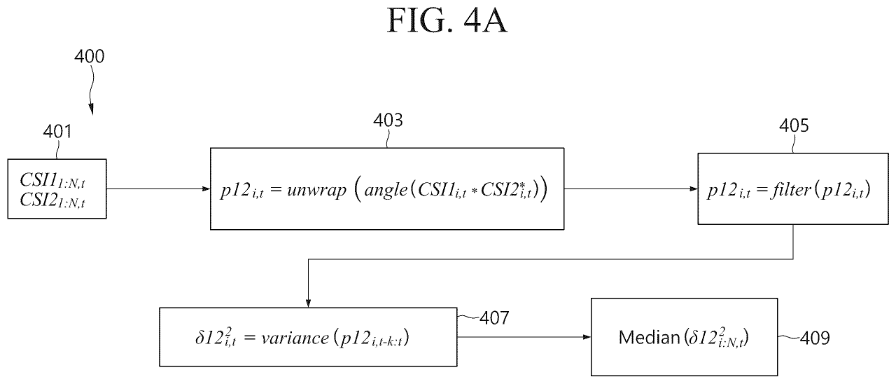

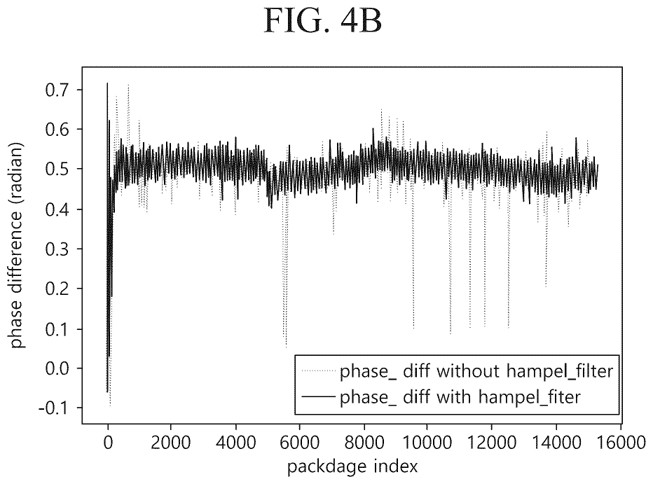

FIG. 4A illustrates a process 400 of computing a median of variances of phase differences in accordance with an embodiment. The following process 400 may be used to calculate variance of phase difference without weight by amplitude in accordance win an embodiment.

In step 401, the process obtains channel state information:

$$CSI {1}_{1 : N , t} \\ CSI {2}_{1 : N , t} \qquad ( 8 a )$$

In step 403, the process computes phase difference p12_{i,t} at time t, and subcarrier i:

$$p {12}_{i , t} = unwrap ( angle ( CS {1}_{i , t} * CS {2}_{i , t )}^{*} ) \qquad ( 8 b )$$

At step 405, the process smooths the phase difference with a filter to remove abnormal data by:

$$p {12}_{i , t} = filter ( p {12}_{i , t} ) \qquad ( 9 )$$

In step 407, the process computes the phase difference δ12_{i,t}² within a sliding window from time t−k to time t:

$${δ12}_{i , t}^{2} = variance ( p {12}_{i , t - k : t} ) \qquad ( 10 )$$

In step 409, the process computes the median of the phase difference δ12_{i,t}².

$$Median ( {δ12}_{i : N , t}^{2} ) \qquad ( 11 )$$

Noise in wireless channels and missed CSI packages may cause abnormal high peaks in the phase differences. In some embodiments, it may be important to address these issues to ensure the accuracy and reliability of data. DBSCAN and Hampel filters may smooth the value of phase differences and remove abnormal data.

FIG. 4B illustrates phase difference with and without Hampel filter in accordance with an embodiment. In FIG. 4B, phase differences with the Hampel filter are smoother than those without the Hamper filter.

Some embodiments may determine Kurtosis of frequency-weighted CSI. In some embodiments, signals can be transmitted through various paths, resulting in a more randomized distribution than those in direct line of sight. The statistical feature kurtosis of CSI amplitudes can distinguish the LOS and NLOS case.

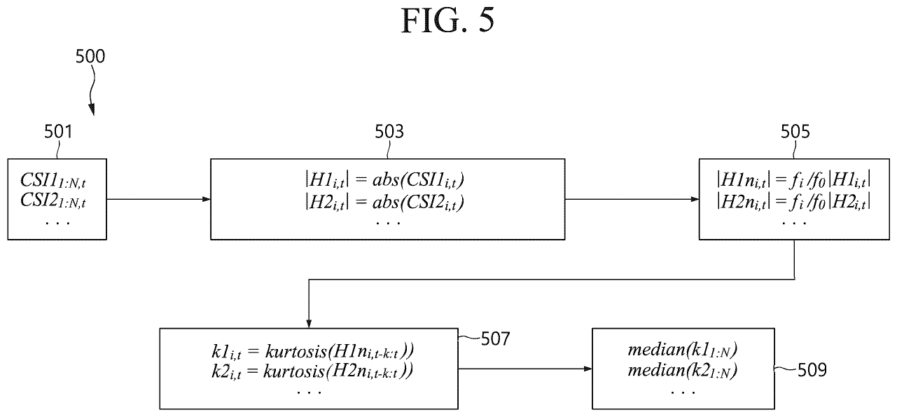

FIG. 5 illustrates an example process 500 of computing kurtosis of frequency-weighted CSI in accordance with an embodiment. In particular, the process 500 illustrated in FIG. 5 may be used in extracting the kurtosis of CSI amplitudes for every antenna in accordance with an embodiment. CSI1_{1:N,t} and CSI2_{1:N,t} are CSI data of antenna 1 and antenna 2 with N subcarriers at time t. The process may calculate the amplitude of every subcarrier. Then, the process may normalize the amplitude of every subcarrier using the ratio of subcarrier's frequency fᵢ and central frequency f₀ of all subcarriers in CSI1 and CSI2. Next, the process may calculate the kurtosis of each subcarrier within a sliding window. Finally, the process may choose a median kurtosis in all subcarriers.

In particular, in step 501, the process may obtain channel state information:

$$CSI {1}_{1 : N , t} \\ CSI {2}_{1 : N , t} \\ … \qquad ( 12 a )$$

In step 503, the process may calculate the amplitude of every subcarrier:

$$\vert H {1}_{i , t} \vert = abs ( CSI {1}_{i , t} ) \\ \vert H {2}_{i , t} \vert = abs ( CSI {2}_{i , t} ) \qquad ( 12 b )$$

In step 505, the process may normalize the amplitude of every subcarrier using the ratio of subcarrier's frequency fᵢ and central frequency f₀ of all subcarriers in CSI1 and CSI2:

$$\vert H 1 {n}_{i , t} \vert = \frac{{f}_{i}}{{f}_{0} \vert H {1}_{i , t} \vert} \\ \vert H 2 {n}_{i , t} \vert = \frac{{f}_{i}}{{f}_{0} \vert H {2}_{i , t} \vert} \\ … \qquad ( 13 )$$

In step 505, the process may calculate the kurtosis of each subcarrier within a sliding window:

$$k {1}_{i , t} = kurtosis ( H 1 {n}_{i , t - k : t} ) ) \\ k {2}_{i , t} = kurtosis ( H 2 {n}_{i , t - k : t} ) ) \qquad ( 14 )$$

In step 509, the process may choose a median kurtosis in all subcarriers:

$$median ( k {1}_{1 : N} ) \\ median ( k {2}_{1 : N} ) \\ … \qquad ( 15 )$$

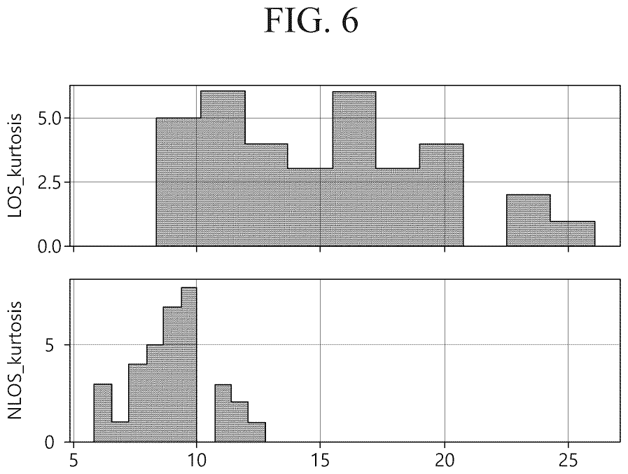

A device in LOS and NLOS will measure different kurtosis of CSI as one testing result illustrated in FIG. 6 in accordance with an embodiment.

FIG. 6 illustrates Kurtosis of a device's CSI in LOS and NLOS in accordance with an embodiment.

Some embodiments may determine a delay spread. Due to the delay and power in propagation paths could be different in LOS/NLOS case, skewness of CIR domain path power, the average delay spread, and RMS delay spread can be deployed for LOS/NLOS identification. The average delay spread of L paths could be described as:

$$\overline{τ} = \frac{{\sum }_{i = 0}^{L - 1} {\vert {a}_{i} \vert}^{2} \cdot {τ}_{i}}{{\sum }_{i = 0}^{L - 1} {\vert {a}_{i} \vert}^{2}} \qquad ( 16 )$$

The RMS delay spread could be described as:

$$RMS delay spread = \sqrt{\frac{{\sum }_{i = 0}^{L - 1} {\vert {a}_{i} \vert}^{2} \cdot {( {τ}_{i} - \overline{τ} )}^{2}}{{\sum }_{i = 0}^{L - 1} {\vert {a}_{i} \vert}^{2}}} \qquad ( 17 )$$

Some embodiments may determine skewness of CIR dominant path power. CIR in NLOS may fluctuate more than CIR in LOS due to multipath propagation in NLOS. The statistical feature called skewness may be used to describe the difference in CIR between obstructed and unobstructed signals.

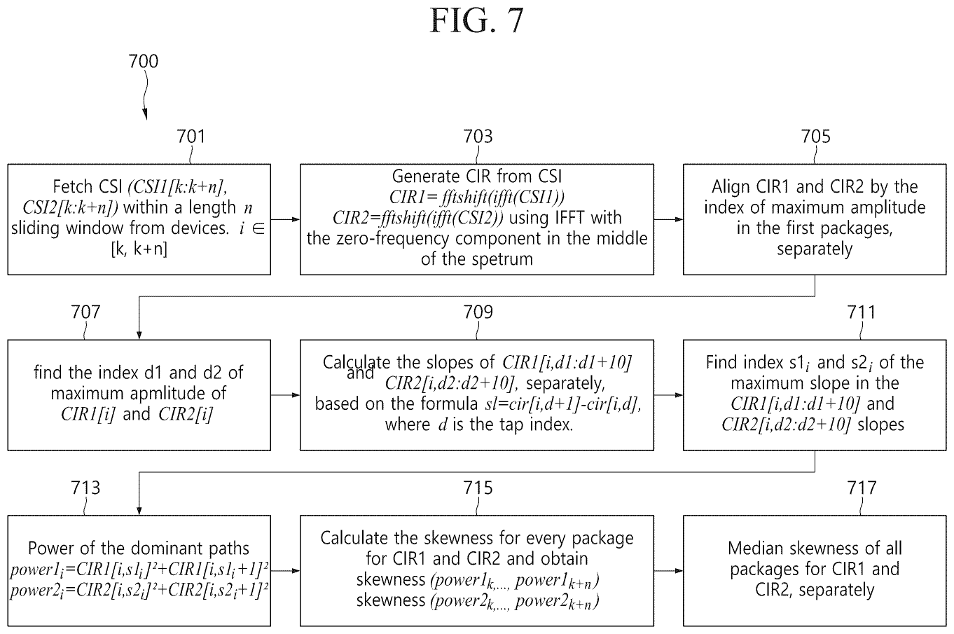

FIG. 7 illustrates an example process 700 of extracting skewness of CIR in accordance with an embodiment. In particular, the process 700 illustrates how to extract skewness for two antennas, but can be applicable to any number of antennas n.

In step 701, the process obtains CSI information from the antennas within a sliding window:

fetch CSI (CSI1[k:k+n], CSI2[k:k+n]) within a length n sliding window from devices.

In step 703, the process generates CIR from CSI using IFFT with the zero-frequency component in the middle of the spectrum:

$$CIR 1 = fftshift ( ifft ( CSI 1 ) ) \qquad ( 18 a )$$

$$CIR 2 = fftshift ( ifft ( CSI 2 ) ) \qquad ( 18 b )$$

In step 705, the process aligns CIR1 and CIR2 by the index of maximum amplitude in the first packages, separately.

In step 707, the process finds the index d1 and d2 of maximum amplitude for CIR1[i] and CIR2[i], where i∈[k,k+n].

In step 709, the process calculate the slopes of CIR1[i, d1: d1+10] and CIR2[i, d2: d2+10], separately, based on the formulate sl=cir[i, d+1]−cir[i,d], where d is the tap index.

In step 711, the process finds index s1ᵢ and s2ᵢ of the maximum slope in the CIR1[i, d1: d1+10] and CIR2[i, d2: d2+10] slopes.

In step 713, the process computes the power of the dominant paths:

$$power {1}_{i} = CIR {1 [ i , s {1}_{i} ]}^{2} + CIR {1 [ i , s {1}_{i} + 1 ]}^{2} \\ power {2}_{i} = CIR {2 [ i , s {2}_{i} ]}^{2} + CIR {2 [ i , sl {2}_{i} + 1 ]}^{2} \qquad ( 18 c )$$

In step 715, the process computes the skewness for every package for CIR1 and CIR2 and obtain:

$$skewness ( power {1}_{k , … ,} , power {1}_{k + n} ) \qquad ( 19 )$$

$$skewness ( power {2}_{k , … ,} , power {2}_{k + n} )$$

In step 717, the process computes the median skewness of all packages for CIR1 and CIR2, separately.

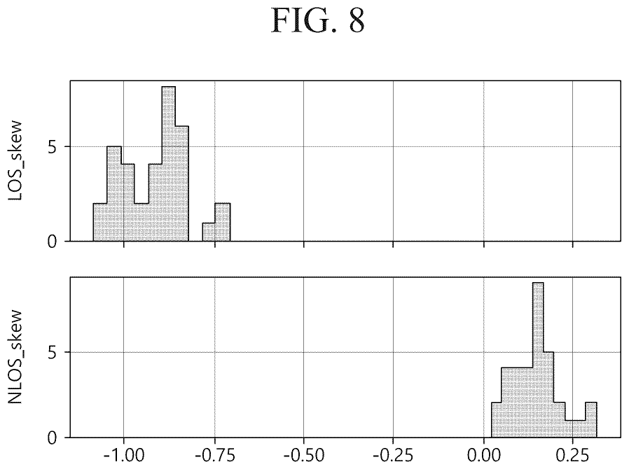

FIG. 8 shows the difference in the skewness of LOS/NLOS in one experiment in accordance with an embodiment. Some embodiments may determine a variance of RTT and RSSI. RTT and RSSI in NLOS may have more random than those in LOS. The variance of distance calculated by RTT and RSSI variance within a sliding window can present the difference between LOS and NLOS. The distance of rx and tx can be calculated using the following equation:

$$distance = \frac{1}{2} * RTT * Vc \qquad ( 20 )$$

where Vc is the speed of light.

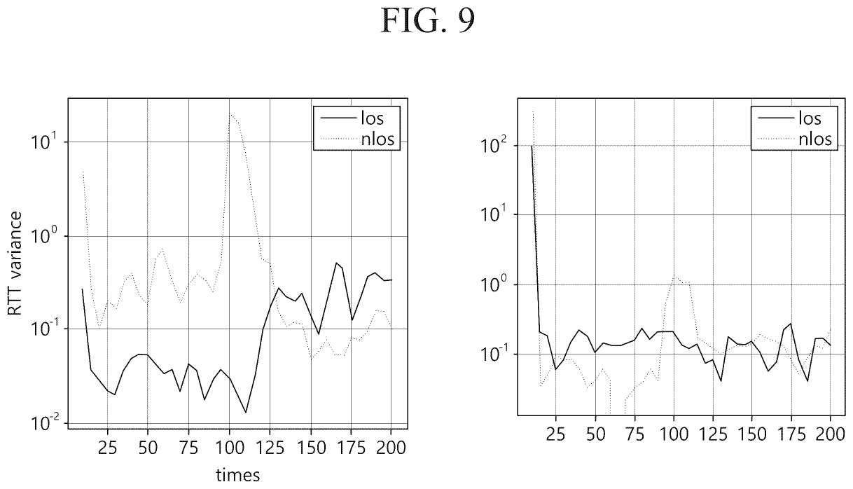

FIG. 9 shows the different pattern of RTT and RSSI variance in one experiment in accordance with an embodiment. Some embodiments may determine features for motion detection. Some embodiments may determine variance and median of standard deviation (STD) of all subcarriers' CSIs. If the motion cuts off Wi-Fi links between devices and Wi-Fi AP, motion can disturb CSIs in an environment so that the median STD of all subcarriers' CSI (csi_std_mid) or variance of all subcarriers' CSI STD (csi_std_var) as described below can reveal environment changes.

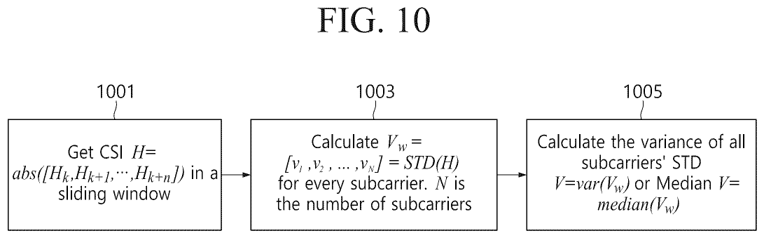

FIG. 10 illustrates an example process 1000 to compute the variance or median of all subcarriers' CSI STD in a sliding window in accordance with an embodiment.

In step 1001, the process obtains CSI in a sliding window by:

$$CSI H = abs ( [ {H}_{k} , {H}_{k + 1 ,} … , {H}_{k + n} ] ) \qquad ( 21 )$$

In step 1003, the process computes the STD for every subcarrier, where Nis the number of subcarriers:

$${V}_{w} = [ {v}_{1 ,} {v}_{2 ,} … {v}_{n} ] = STD ( H ) \qquad ( 22 )$$

In step 1005, the process computes the variance of all subcarriers' STD:

$$V = var ( {V}_{w} ) or median V = median ( {V}_{w} ) \qquad ( 23 )$$

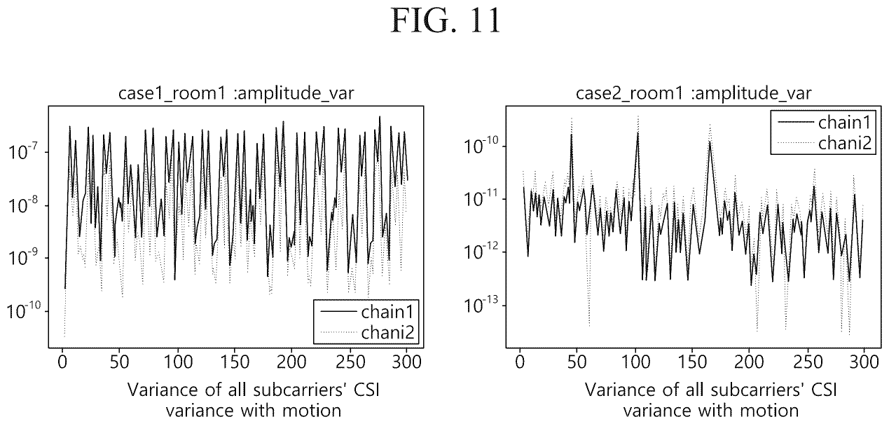

FIG. 11 shows the variance of all subcarriers' CSI variances in a room with motion that has larger values compared with variances in a room without motion in accordance with an embodiment. Some embodiment may determine a median standard deviation (STD) of CSI difference.

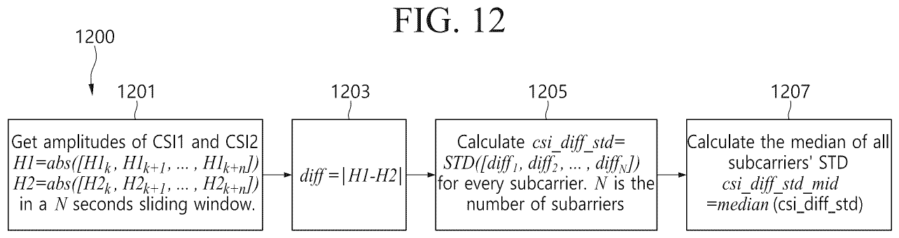

FIG. 12 illustrates an example process of determining a median STD of CSI difference in accordance with an embodiment. The process 1200 may be used for calculating a median STD of CSI difference (csi_diff_std_mid) between two antennas in accordance with an embodiment. In particular, the process 1200 may compute the absolute amplitude difference between CSI1 and CSI2. The process 1200 may compute the STD of every subcarrier. The process 1200 may compute median of STDs of all subcarriers.

In particular, in step 1201, the process computes amplitudes of CSI1 and CSI2 in a n second sliding window:

$$H 1 = abs ( [ H {1}_{k ,} H {1}_{k + 1 ,} … , H {1}_{k + n} ] ) \qquad ( 24 )$$

$$H 2 = abs ( [ H {2}_{k ,} H {2}_{k + 1 ,} … , H {2}_{k + n} ] ) \qquad ( 25 )$$

In step 1203, the process computes the difference between the amplitudes of the two antennas:

$$diff = \vert H 1 - H 2 \vert \qquad ( 26 )$$

In step 1205, the process computes the STD of every subcarrier, where N is the number of subcarriers:

$$csi\_diff \_std = STD ( [ {diff}_{1} , {diff}_{2 ,} … , {diff}_{N} ] ) \qquad ( 27 )$$

In step 1207, the process computes the median of all subcarriers' STD:

$$csi\_diff \_std \_mid = median ( csi\_diff \_std ) \qquad ( 28 )$$

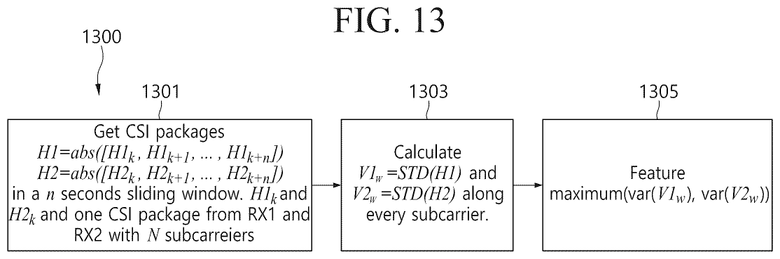

FIG. 13 illustrates a process for determining a maximum variance of CSI in accordance with an embodiment. The process 1300 obtains in step 1301 CSI packages in a n seconds sliding window, where H1ₖ and H2ₖ are one CSI package from RX1 and RX2 with N subcarriers:

$$H 1 = abs ( [ H {1}_{k ,} H {1}_{k + 1 ,} … , H {1}_{k + n ,} ] ) \qquad ( 24 b )$$

$$H 2 = abs ( [ H {2}_{k ,} H {2}_{k + 1 ,} … , H {2}_{k + n ,} ] ) \qquad ( 25 b )$$

In step 1303, the process computes V1_{w}=STD (H1) and V2_{w}=STD (H2) along every subcarrier.

In step 1305, the process determines feature maximum (var(V1_{w}), var(V2_{w})). In some embodiments, the maximum (variance of CSI STD) in a room with motion is larger than in rooms without motion, when an object walks in one of rooms 1, 2 . . . n. In some embodiments, maximum (variance of CSI STD) in any room may be disturbed by motion in the AP room.

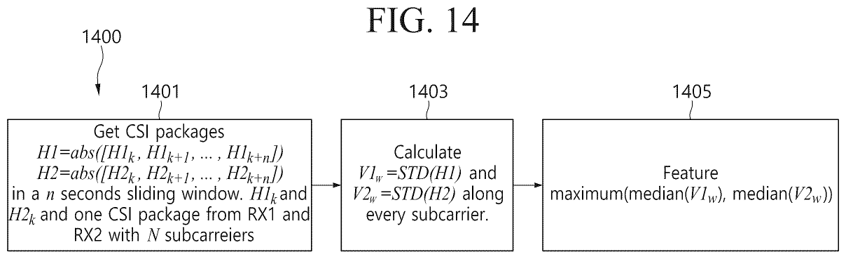

FIG. 14 illustrates a process for determining a maximum median of CSI in accordance with an embodiment. The process 1400 obtains in step 1401 CSI packages in a n seconds sliding window, where H1ₖ and H2ₖ are one CSI package from RX1 and RX2 with N subcarriers:

$$H 1 = abs ( [ H {1}_{k ,} H {1}_{k + 1 ,} … , H {1}_{k + n ,} ] ) \qquad ( 24 c )$$

$$H 2 = abs ( [ H {2}_{k ,} H {2}_{k + 1 ,} … , {H2}_{k + n ,} ] ) \qquad ( 25 c )$$

In step 1403, the process computes V1_{w}=STD (H1) and V2_{w}=STD (H2) along every subcarrier.

In step 1405, the process determines feature maximum (median (V1_{w}), median (V2_{w})). In some embodiments, the maximum (median of CSI STD) in a room with motion is larger than in rooms without motion, when an object walks in one of rooms 1, 2 . . . n. In some embodiments, maximum (median of CSI STD) in any room may be disturbed by motion in the AP room.

Some embodiments may determine a variance of CSI difference STD.

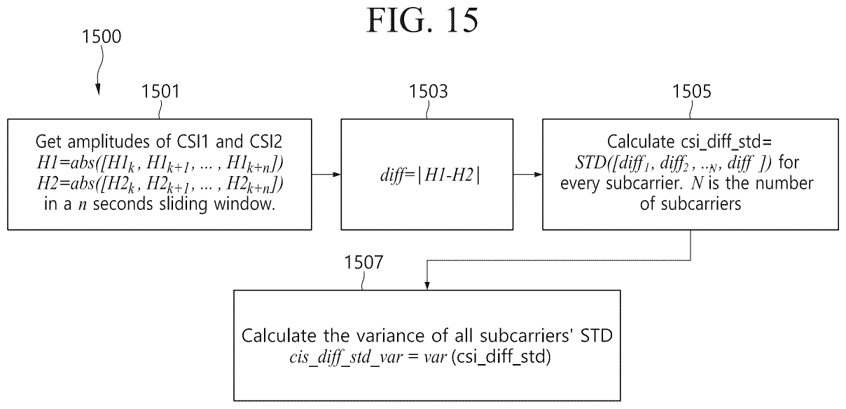

FIG. 15 illustrates a process for determining a variance of CSI difference STD (csi_diff_std_var) between two devices in accordance with an embodiment.

The process 1500, in step 1501 computes the amplitudes of CS1 and CS2 in a n second sliding window:

$$H 1 = abs ( [ H {1}_{k ,} H {1}_{k + 1 ,} … , H {1}_{k + n ,} ] ) \qquad ( 29 )$$

$$H 2 = abs ( [ H {2}_{k ,} H {2}_{k + 1 ,} … , H {2}_{k + n ,} ] ) \qquad ( 30 )$$

In step 1503, the process computes the difference between the amplitudes of the two antennas:

$$diff = \vert H 1 - H 2 \vert \qquad ( 31 )$$

In step 1505, the process computes the STD of every subcarrier, where N is the number of subcarriers:

$$csi\_diff \_std = STD ( [ {diff}_{1} , {diff}_{2 ,} … , {diff}_{N} ] ) \qquad ( 31 )$$

In step 1507, the process computes the variance of all subcarriers' STD:

$$csi\_diff \_std \_var = var ( csi\_diff \_std ) \qquad ( 32 a )$$

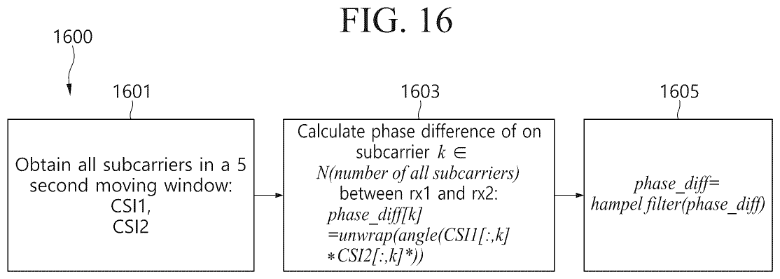

FIG. 16 illustrates computing phase difference in accordance with an embodiment. The process 1600 in step 1601 obtains all subcarriers in a n second moving window (e.g., 5 second window): CS1, CS2.

In step 1603, the process calculates the phase difference of one subcarrier k E N(number of all subcarriers) between rx1 and rx2:

$$phase\_diff [ k ] = unwrap ( angle ( CSI 1 [ : , k ] * CSI {2 [ : , k ]}^{*} ) ) \qquad ( 32 b )$$

In step 1605, the process computes:

$$phase\_diff = hampel filter ( phase\_diff ) \qquad ( 32 c )$$

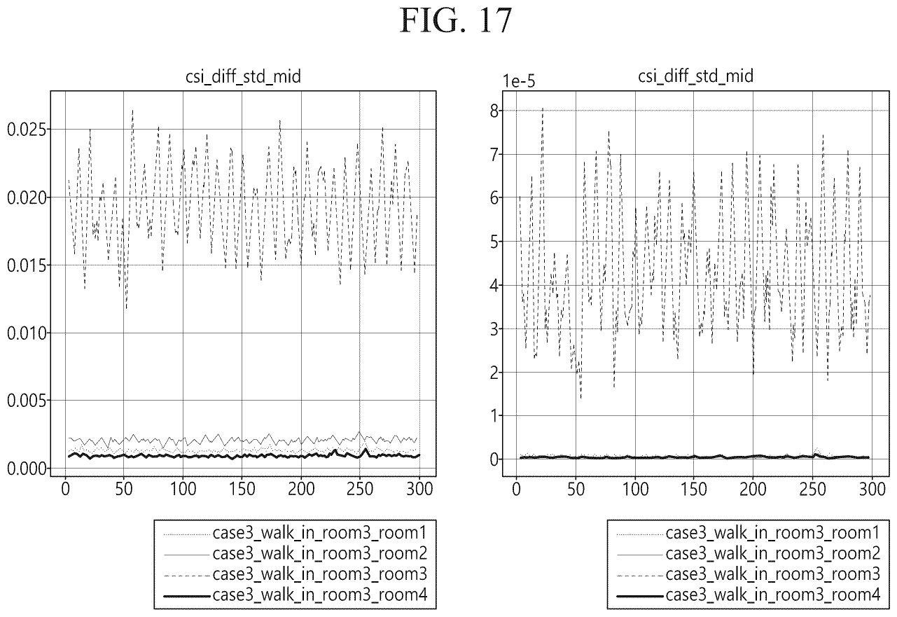

FIG. 17 shows the csi_diff_std_mid and csi_diff_std_var for motion cases and empty cases in an experiment in accordance with an embodiment. In the example, a user walks in the room 3 and there are no other users in the other rooms. As illustrated, the motion in room 3 disturbs the CSI in room 3 to cause the csi_diff_std_mid and csi_diff_std_var in room 3 to be higher than ones in other rooms.

Some embodiments may determine a phase difference of different antennas. When motion disturbs the CSIs between devices and Wi-Fi AP, the phase difference for subcarriers between antennas also changes. The phase difference can be calculated using steps described to calculate the variance of phase difference above.

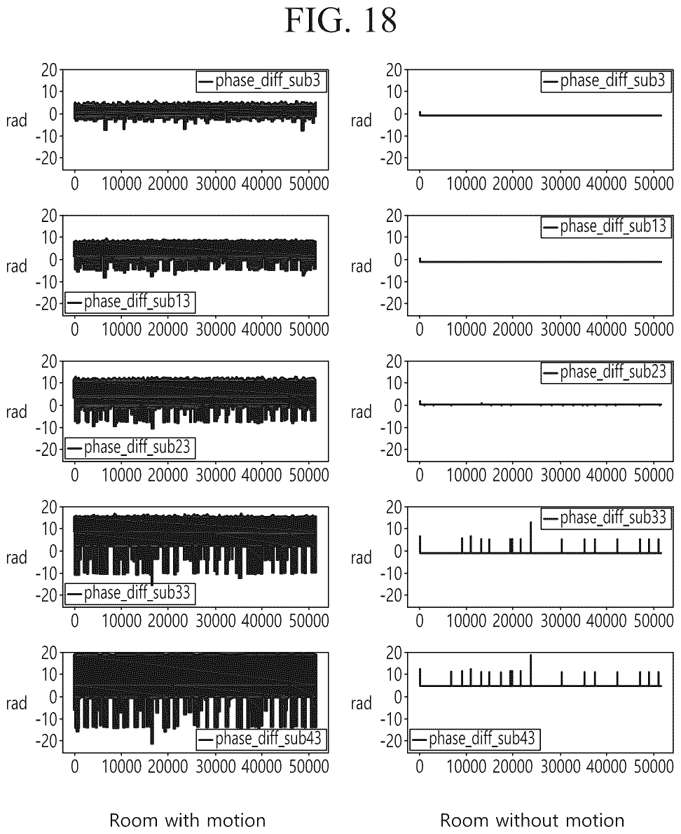

FIG. 18 illustrates a phase difference of some subcarriers between two antennas in accordance with an embodiment. In FIG. 18, the phase differences of subcarriers between two antennas in a room with motion have more fluctuation than the phase difference in a room without motion. FIG. 18 illustrates the results on some subcarriers selected randomly.

Some embodiments may determine statistical features of RSSIs. Motion in rooms can influence the RSSI in the environment. The variance of RSSI can differentiate the empty room and occupied room.

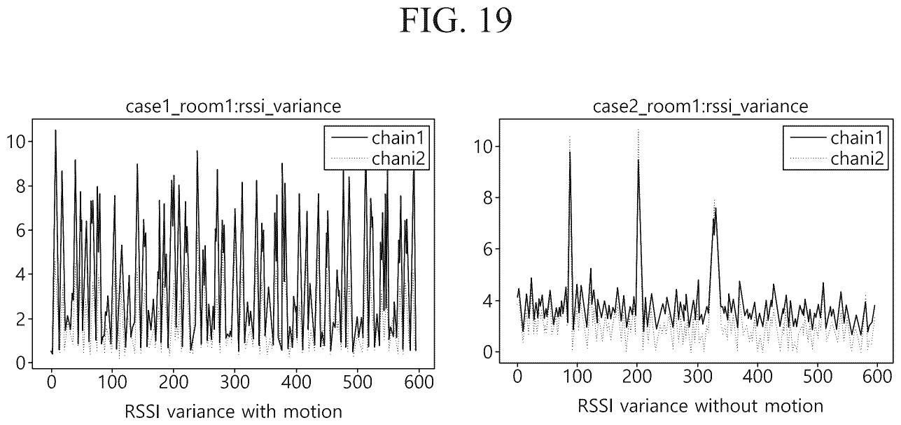

FIG. 19 illustrates RSSI variances with and without motion in accordance with an embodiment.

In some embodiments, the RSSI variance may be calculated by the variance of RSSI data within a time sliding window.

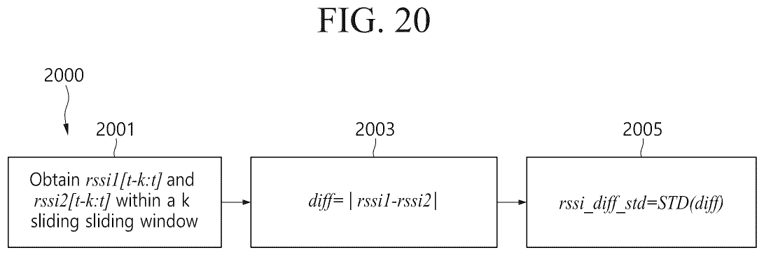

FIG. 20 illustrates an example process of computing STD of RSSI difference in accordance with an embodiment. In particular, the STD of RSSI difference (rssi_diff_std) between two antennas may be calculated.

The process 2000 may in step 2001 obtain rssi1[t−k:t] and rssi2[t−k:t] within a k seconds sliding window.

In step 2003, the process may compute the difference in RSSI:

$$diff = \vert rssi 1 - rssi 2 \vert \qquad ( 33 )$$

In step 2005, the process may compute the STD of the RSSI difference:

$$rssi\_diff \_std = STD ( diff ) \qquad ( 34 )$$

Some embodiments may determine features extracted by principal component analysis (PCA). PCA can be used to analyze the features from CSI and reduce the feature size, especially when there are multiple subcarriers in a long sliding window.

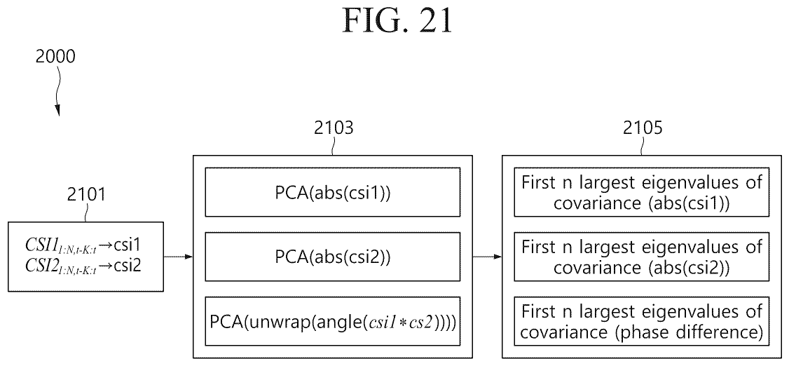

FIG. 21 illustrates a process of feature extraction using PCA to analyze CSI in accordance with an embodiment. In particular, FIG. 21 illustrates a process 2100 computing the first n largest eigenvalues of auto covariance of amplitude and phase difference between two antennas in accordance with an embodiment.

In step 2101, the process obtains CSI for N subcarriers at time t:

$$CSI {1}_{1 : N , t} \to csi 1 \\ CSI {2}_{1 : N , t} \to csi 2 \qquad ( 35 )$$

In step 2103, the process computes PCA of amplitude and phase difference between two antennas: PCA(abs(csi1)), PCA(abs(csi2)), PCA(unwarp(angle(csi1*csi2*))).

In step 2105, the process determines the first n largest eigenvalues of auto covariance of amplitude and phase difference between two antennas. In particular, in step 2105, the process determines first n largest eigenvalues of covariance (abs(csi1)), determines first n largest eigenvalues of covariance (abs(csi2)), and determine first n largest eigenvalues of covariance (phase difference).

In some embodiments, presence detection can be achieved through the use of links between multiple devices and an AP. For instance, consider a scenario where an AP is located in one room and at least one device is placed in each room.

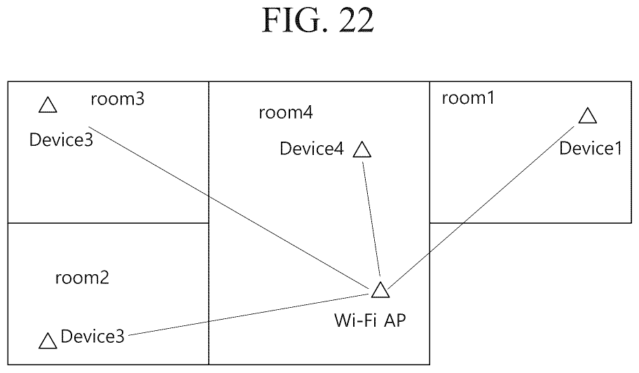

FIG. 22 illustrates an example of multi-links between devices and an AP in accordance with an embodiment. As illustrated, the environment includes room1 with device 1, room2 with device 2, room3 with device 3, and room4 with device 4 and Wi-Fi AP. In this setup, CSI data is transmitted between the AP and each device through a link. Whenever a user walks into any of the rooms, the CSI pattern in one or multiple links would be disturbed due to the movement. The describer features herein can be employed for the presence detection (motion detection) in threshold-based methods, machine learning and/or deep learning techniques.

Some embodiments may determine presence detection based on a threshold method.

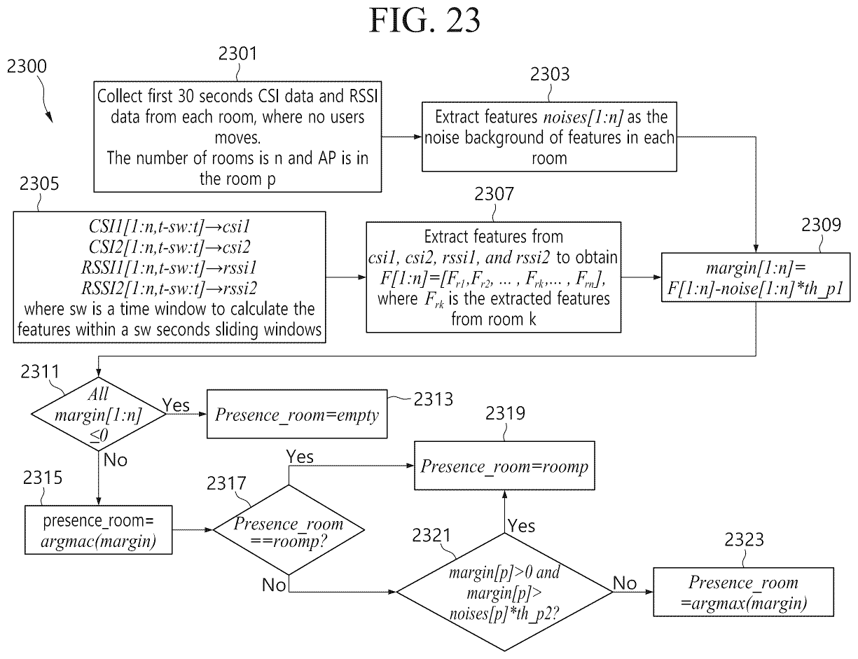

FIG. 23 illustrates an example flow chart of a process for presence detection based on a threshold method in accordance with an embodiment. To summary FIG. 23, the process 2300 may use a threshold method based features extracted from CSI and RSSI that can be deployed to detect if an object walks in a room. The process 2300 may collect data (step 2301) in each room without users for a particular time value (e.g., 30 seconds) and then calculate noise background (step 2303) of each room with one of five features as below.
Features1: csi_diff_std
Features2: csi_diff_var
Features3: maximum (rx1 csi_std_mid, rx2 csi_std_mid)
Features4: maximum (rx1 csi_std_var, rx2 csi_std_var)
Features5: rssi_diff_std

The process 2300 may calculate (step 2305) these features within a time sliding window and then compared to the noises background with parameter th_p1 which may be used to adjust the noises values. If all elements in margin array are less than 0 (step 2311), the presence result is empty (step 2313). Otherwise, the process may find out the index of maximum element in margin array (step 2315). If the presence_room is the room with Wi-Fi AP (room p) (step 2317), the presence result is the room with AP (step 2319). If the index of maximum value in margin is not the room p, check if margin[p]>0 and margin[p]>noises[p]*th_p2 (step 2321). Parameter th_p2 may be used to control the values of noise background in room p. If margin[p]>0 and margin[p]>noises[p]*th_p2, the presence result is the room p (step 2319). Otherwise, the final result is the index of maximum element in margin array, which is argmax (margin) (step 2323).

In particular, as illustrated in FIG. 23, in step 2301, the process collects a first time period (e.g., 30 seconds) CSI data and RSSI data from each room, where no users move. The number of rooms is n and AP is in room p.

In step 2303, the process extracts features noises[1:n] as the noise background of features in each room.

In step 2305, the process computes:

$$CSI 1 [ 1 : n , t - sw : t ] \to csi 1 \\ CSI 2 [ 1 : n , t - sw : t ] \to csi 2 \\ RSSI 1 [ 1 : n , t - sw : t ] \to rssi 1 \\ RSSI 2 [ 1 : n , t - sw : t ] \to rssi 2 \qquad ( 36 a )$$

where sw is a time window to calculate the features within a sw seconds sliding window.

In step 2307, the process extracts features from csi1, csi2, rssi1 and rssi2 to obtain F[1:n]=[Fᵣ₁, Fᵣ₂, F . . . , Fᵣₖ, . . . , Fᵣₙ], where Fᵣₖ is the extracted features from room k.

In step 2307, the process computes the margin:

$$Margin [ 1 : n ] = F [ 1 : n ] - noises [ 1 : n ] * th\_p 1 \qquad ( 36 b )$$

The output of steps 2303 and 2307 are provided to step 2311 where the process determines:

$$All margin [ 1 : n ] <= 0 \qquad ( 36 c )$$

In step 2311, if it is determined that the answer is yes, the process proceeds to step 2313, otherwise, the process proceeds to step 2315.

In step 2313, the process determines that the room is empty, Presence_room=empty

In step 2315, the process finds out the index of the maximum element in the margin array, Presence_room=argmax (margin).

In step 2317, the process determines whether the presence_room is the room with the Wi-Fi AP, Presence_room==room p?

If the process in step 2317 determines that the presence_room is the room with the Wi-Fi AP, the process proceed to 2319, otherwise the process proceeds to step 2321.

In step 2319, if the process determines that the presence result is the room with the AP, Presence_room=room p.

In step 2319, if the process determines the index of maximum value in margin is not the room p, the process proceeds to step 2321.

In step 2321, the process determines whether: margin[p]>0 and margin[p]>noises[p]*th_p2?

In step 2321, if the process determines that margin[p]>0 and margin[p]>noises[p]*th_p2, the process proceeds to step 2319, where the presence result is room p.

In step 2321, if the process determines that margin[p]>0 and margin[p]>noises[p]*th_p2 is not satisfied, the process to step 2323 where the final result is Presence_room=argmax (margin).

Some embodiments may determine presence detection based on machine learning and deep learning.

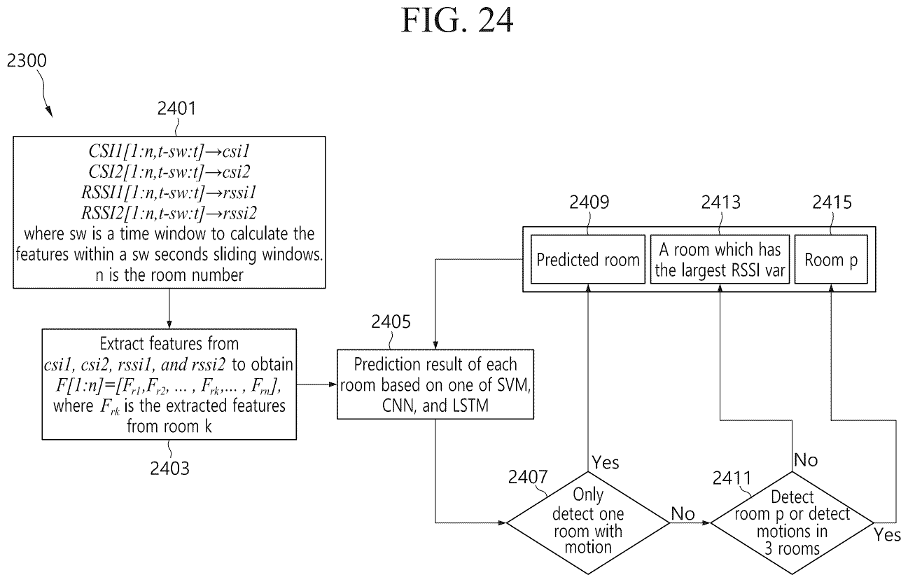

FIG. 24 illustrates a process of presence detection based on machine learning and deep learning in accordance with an embodiment. FIG. 24 illustrates the process 2400 of presence detection using multi-links based on machine learning and deep learning methods. The process 2400 may extract features from CSI and RSSI in each room (step 2401 and 2403) which may be sent to one of the pre-trained models (step 2405), support vector machine (SVM), convolutional neural network (CNN), or long short-term memory network (LSTM), to predict the presence in that room. The process may use a state machine to collect the results of the model in all rooms and then makes the final presence decision. The state machine may increase the accuracy of multi-link presence detection by handling the interference between links. Since motion in the Wi-Fi AP room disturbs CSI and RSSI in other rooms and motion in one room could disturb another room's CSI and RSSI, it may be difficult for a pre-trained model to handle interference between links. In some embodiments, a state machine can complement the pre-trained model by making predictions based on the results of the multi-link presence detection. If the model predicts motion in one room (step 2407), the final output is the predicted room (step 2409). If the model predicts motion in three rooms or in the Wi-Fi AP room (2411), the final result is motion in the Wi-Fi AP room (2415). If the number of rooms is two and the Wi-Fi AP room is not in the prediction results (2411), the final output is the room with the higher RSSI variance (2413).

In particular, in step 2410, the process obtains CSI and RSSI information:

$$CSI 1 [ 1 : n , t - sw : t ] \to csi 1 \\ CSI 2 [ 1 : n , t - sw : t ] \to csi 2 \\ RSSI 1 [ 1 : n , t - sw : t ] \to rssi 1 \\ RSSI 2 [ 1 : n , t - sw : t ] \to rssi 2 \qquad ( 37 )$$

where sw is a time window to calculate the features within a sw seconds sliding windows. N is the room number.

In step 2430, the process extracts features from csi1, csi2, rssi1 and rssi2 to obtain F[1:n]=[Fᵣ₁, Fᵣ₂, F . . . , Fᵣₖ, . . . , Fᵣₙ], where Fᵣₖ is the extracted features from room k.

In step 2405, the process computes prediction results of each room based on one of SVM, CNN, and LTSM.

In step 2407, the process determines whether it only detects one room with motion.

In step 2407, if the process determines that it only detects one room with motion, the process proceeds to step 2409 and the final output is the predicted room.

In step 2407, if the process determines that it does not only detect one room with motion, the process proceeds to step 2411 to determine whether it detects motion in room p (the wi-fi AP room) or detects motions in 3 rooms.

In step 2411, if the process determines that it does detect motion in room p or detects motions in 3 rooms, the process proceeds to step 2415 where the final result is motion in the room p, where p the wi-fi AP room.

In step 2411, if the process determines that it does not detect motion in room p or detects motions in 3 rooms, the process proceeds to step 2413. In particular, in step 2407, if the number of rooms is two and the Wi-Fi AP room is not in the prediction results, the process proceeds to step 2413 where the final output is the room with the higher RSSI variance.

In some embodiments, in order to train a model, a user may need to collect CSI and RSSI in each room with a walking case and an empty case for some time period (e.g., minutes, such as one minute, separately). These data may be used to train a model for all rooms to decide if a user is in one room or not.

Some embodiments may determine presence detection based on SVM. SVM models with the kernel radial basis function can be trained and deployed using one feature from the following features described below.
Feature1 [the first 6 eigenvalues of PCA (phase difference), csi_diff_std_mid,csi_diff_std_var,rssi_diff_sto [symbol] ]
Feature2: [csi1_std_mid,csi1_std_var,csi2_std_mid,csi2_std_var,csi_diff_std_mid,csi_diff_std_var,
rssi_diff_std,rssi1 var,rssi2 var]
Feature3: [csi1_std_mid,csi1_std_var,csi2_std_mid,csi2_std_var,csi_diff_std_mid,csi_diff_std_var]
Feature 4: [rssi_diff_std,rssi1_var,rssi2_var]

In some embodiments, csi1 and rssi1 are from the antenna 1 and csi2 and rssi2 are from the antenna 2.

Some embodiments may determine presence detection based on CNN and LSTM. In some embodiments, a deep learning method could learn a motion model using raw CSIs in a time sliding window.

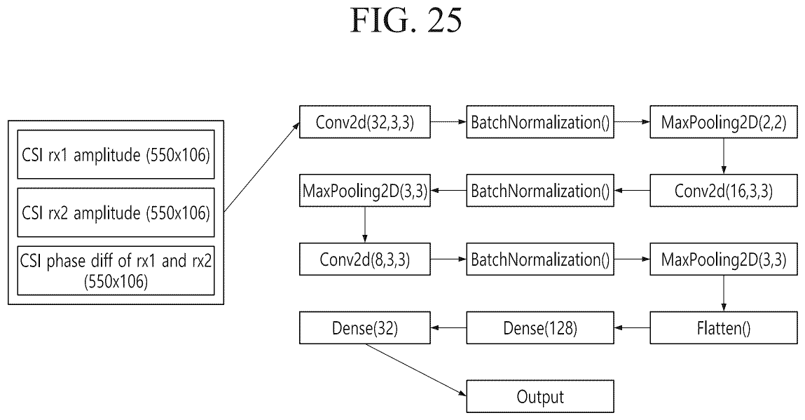

FIG. 25 illustrates a CNN model for presence detection for one room in accordance with an embodiment. The features are amplitudes of CSI1 and CSI2 and phase difference between CSI1 and CSI2 with 106 subcarriers (Wi-Fi bandwidth is 40 Mhz). The model output is motion or no motion in one room.

In CNN model, the Conv2d is a 2-dimensional convolution layer to extract the information from inputs. Function Conv2d(filtersₙᵤₘ,kernel size(M, N)) is implemented as below.

$${H}_{ijk} = a [ {β}_{k} + {\sum }_{m = 1}^{M} {\sum }_{n = 1}^{N} {ω}_{mnk} {x}_{i - m , j - n} ] \qquad ( 38 )$$

where kϵ[0, filtersₙᵤₘ], βₖ is the bias and ωₘₙₖ are the entries of the convolutional kernel of filter k. βₖ and ωₘₙₖ are trainable parameters. Function a[ ] is activation function, which can be implemented using rectified linear unit (ReLU)

ReLU:a(x)=max(0,x) (39)

BatchNormalization can help to resolve the vanishing gradients and exploding gradients which occur during the deep learning model's training. BatchNormalization can be described as the following equations

$${μ}_{i} = \frac{1}{K} {\sum }_{n = 1}^{K} {a}_{ni} \qquad ( 40 )$$

$${δ}_{i}^{2} = \frac{1}{K} {\sum }_{1}^{K} {( {a}_{ni} - {μ}_{i} )}^{2} \qquad ( 41 )$$

$${\hat{a}}_{ni} = \frac{{γ}_{i} ( {a}_{ni} - {μ}_{i} )}{\sqrt{{δ}_{i}^{2} + ϵ}} + {β}_{i} + \qquad ( 42 )$$

Where activation aₙᵢ is the iₜₕ dimension's value of the nₜₕ example in a min-batch. The size of mini-batch is K; ϵ is small constant to avoid numerical issue in situations where δᵢ² is small; γᵢ and βᵢ are parameters learned during training. âₙᵢ is the output of BatchNormalization(aₙᵢ);

Maxpooling2D(m, n) is used to reduce the spatial dimensions of the input volume for the next layer. This function can be described as below.

$$O ( x , y ) = {max}_{0 \leq i < m , 0 \leq j < n} X ( sx + i , sy + j ) \qquad ( 43 )$$

Where i and j are indices within the pooling window, s is the stride of the pooling operation, (m, n) is the size of pooling window, (x, y) is the position at the output O.

Flatten( ) is an operation to convert the n-dimensional tensor into a 1-dimensional tensor.

Dense(n) is a fully connected layer, which can be described as below.

$$y = Dense ( n ) = a ( Wx + b ) \qquad ( 44 )$$

Where a( ) is an activation function, x is input, b is bias, W is the matrix of weights learned during training and n is the dimensionality of the output space.

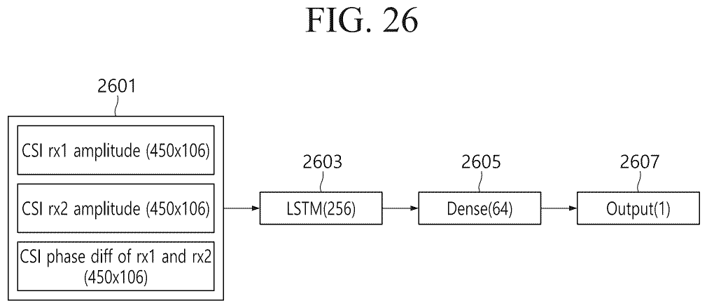

FIG. 26 illustrates a long short-term memory network (LSTM) method for motion detection in accordance with an embodiment. The inputs 2601 are the CSI amplitudes of antenna 1 and antenna 2 and the phase difference between the two antennas which is provided to the LSTM 2603. The input may be the latest 450 packages of all subcarriers. The dense 2605 block may be a fully connected layer as described by equation 44. The output 2607 is motion or no motion in one room.

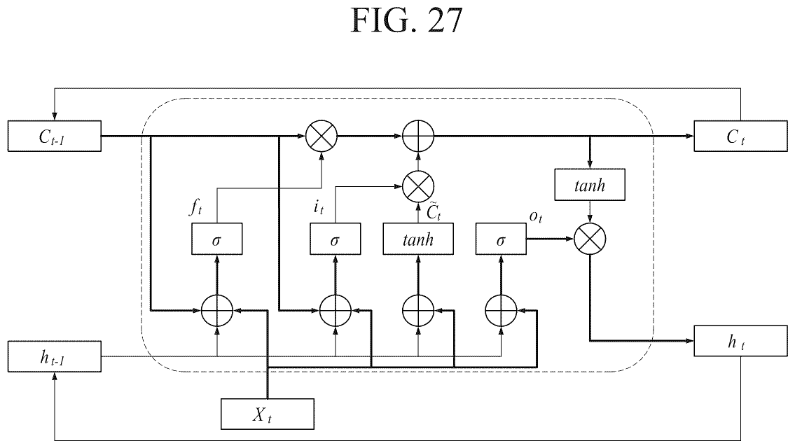

FIG. 27 illustrates a process of LSTM in accordance with an embodiment. Ct is the memory unit at time t. hₜ is the output of LSTM at t. Xₜ is the input of LSTM at t. σ is the sigmoid function. The implementation of LSTM is based on the following equations below.

$${f}_{t} = σ ( {W}_{f} [ {h}_{t - 1} , {X}_{t} ] + {b}_{f} ) \qquad ( 45 )$$

$${i}_{t} = σ ( {W}_{i} [ {h}_{t - 1} , {X}_{t} ] + {b}_{i} ) \qquad ( 46 )$$

$${\tilde{C}}_{t} = tanh ( {W}_{c} [ {h}_{t - 1} , {X}_{t} ] + {b}_{c} ) \qquad ( 47 )$$

$${C}_{t} = {f}_{t} * {C}_{t - 1} + {i}_{t} * {\tilde{C}}_{t} \qquad ( 48 )$$

$${o}_{t} = σ ( {W}_{o} [ {h}_{t - 1} , {X}_{t} ] + {b}_{o} ) \qquad ( 49 )$$

$${h}_{t} = {o}_{t} * tanh ( {C}_{t} ) \qquad ( 50 )$$

Where b_{f}, bᵢ and b_{c} are biases. W_{f}, Wᵢ, Wo and W_{c} are weights for their functions.

Some embodiments may determine presence detection with Graph Neural Network. In some embodiments, this setup of devices and AP forms a graph, where the devices and AP represent nodes, and the links between them represent edges. To detect the presence of a user and predict which room they are in, Graph Neural Network (GNN) can be used to train a presence detection model with multi-links. When CSI data is transmitted between two devices, it provides additional information to the GNN model, thereby improving its accuracy.

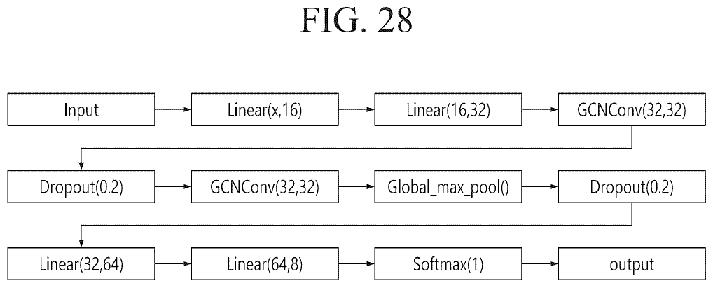

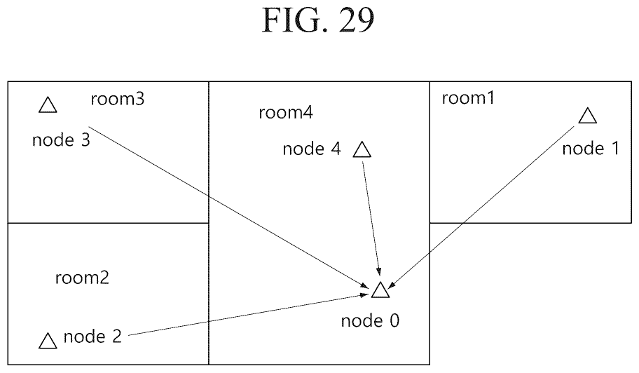

FIG. 28 illustrates a built GNN model in accordance with an embodiment. FIG. 29 illustrates a building with four rooms and an AP positioned in a particular room in accordance with an embodiment. The input is the csi_diff_std_mid data of all rooms within a time sliding window and edge information [1→0, 2→0,3→0,4→0], where 0 is Wi-Fi AP, [1, 2, 3, 4] are the index of devices in room 1, 2, 3, and 4 (shown in FIG. 29).

The GCNConv(nᵢ,nⱼ) is implemented based on the following layer-wise propagation rule

$${H}^{l + 1} = σ ( {\tilde{D}}^{\frac{1}{2}} \hat{A} {\tilde{D}}^{- \frac{1}{2}} {H}^{l} {W}^{l} ) \qquad ( 51 )$$

Where nᵢ and nⱼ are the size of each input sample and the size of each output sample; H^{l} is the output from layer l; σ is a ReLU activation function; Â is the adjacency matrix with self-loops and \tilde{D}ᵢᵢ=ΣⱼÂᵢⱼ. i and j are the node indexes.

Dropout(p) is to set up an element to be 0 with the probability p from a Bernoulli distribution.

Linear(iₙ, oₙ) is same with the Dense function, where iₙ is the input size and oₙ is the output size.

Global_mas_pool( )) can computed by rᵢ=maxₙ₌₁^{N}xₙ, where N is the node number in one graph, xₙ is the node feature matrix.

Some embodiments may determine an interface between Application Processor (on device) with the WiFi chip. In order to obtain WiFi data, such as CSI, RSSI, it may be necessary to define the interface between the Application Processor (on device) with the WiFi chip. Described below is a reference interface, including configuration and control request, as well as data types being returned from the WiFi chip.

In some embodiments, STA devices can be set to one of the two following modes: (1) passive mode (listening), and (2) active mode. Described below are the APIs (including inputs and outputs) between the Application Processor and vendor's WiFi chip, and a reference test setup in which a PC connecting to the STA through adb connection to set up configuration parameters, then during the WiFi communication between the STA and APs, the CSI data is streamed and saved on the PC for further processing.

### API for Passive Mode: Configuration and Control

In passive mode, the STA can measure CSI for all IEEE 802.11a/g/n/ac/ax/be frames transmitted over the air on the same channel from other WiFi devices.

### API Between the Application Processor and WiFi Chip

| Categories | Fields | Description | Format |
|---|---|---|---|
| Configu- | Mode | Mode = 0 (passive mode) | 1 byte |
| ration | ChanSpec | A chanspec holds the channel | 2 bytes |
| | | number, band, bandwidth and | |
| | | control sideband information. | |
| | | The format of the chanspec | |
| | | is as follows: | |

| Bits | Description |
|---|---|
| 7-0 | Channel number |
| 9-8 | 1: lower control |
| | sideband |
| | 2: upper control |
| | sideband |
| | 3: no control |
| | sideband |
| 12-10 | 1: 20 MHz |
| | bandwidth |
| | 2: 40 MHz |
| | bandwidth |
| | 3: 80 MHz |
| | bandwidth |
| | 4: 160 MHz |
| | bandwidth |
| | 5: 320 MHz |
| | bandwidth |
| 15-13 | 1: 2 GHz band |
| | 2: 5 GHz band |
| | 3: 6 GHz band |

| | | | |
|---|---|---|---|
| | Core mask | A bit mask with the ID of the cores | 1 byte |
| | | (receiving antennas) to activate | |
| | | capture (e.g. 0x5 = 0b0101 means | |
| | | setting cores 0 and 2) | |
| | Nsmask | A bit mask with spatial stream IDs | 1 byte |
| | | to capture (e.g. 0x7 = 0b0111 means | |
| | | capturing the first 3 spatial streams | |
| | Frame | Specifies the frame types that are | 1 byte |
| | type | desired to be recorded | |
| | Source | Sets the list of MAC addresses of | 1 + 6*N |
| | MAC | the WiFi devices that are desired to | bytes |
| | addresses | listen to. The first byte specifies N, | |
| | | the number of WiFi devices to listen | |
| | | to. Then the next 6*N bytes are the | |
| | | MAC addresses of the N devices (6 | |
| | | bytes/device) | |
| | CSI type | 1: Legacy CSI (L-LTF) | 1 byte |
| | | 2: Generation-specific CSI (HT- | |
| | | LTF, VHT-LTF, HE-LTF, EHT- | |
| | | LTF) | |
| | Duration | Sets the duration (in seconds) of the | 2 bytes |
| | | subsequent CSI collection session. If | |
| | | this configuration is not set, the CSI | |
| | | collection will run indefinitely until | |
| | | manual stop. | |
| | Report | Sets the interval (in milliseconds) of | 2 bytes |
| | interval | the CSI report from the module | |
| Control | Start -N | Start CSI data collection after N | |
| | | seconds (when N = 0, start CSI | |
| | | collection immediately) | |
| | Stop -M | Stop the CSI collection after M | |
| | | seconds (when M = 0, stop CSI | |
| | | collection immediately) | |

### Reference Test Setup

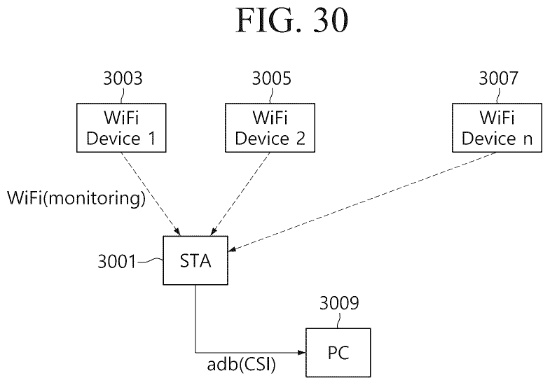

FIG. 30 illustrates a reference test setup in accordance with an embodiment. The reference test setup may include an STA 3001, wifi device 1 3003, wifi device 2 3005, to wifi device n 3007. The information from WiFi monitoring may be provided to a PC 3009.

On PC 3009, the command line tool may first accepts configuration options from a user to setup a CSI data collection session, which may include: $ wificsi_cli --mode 0--chanspec [chanspec]--coremask [coremask]--nsmask [nsmask] --duration [duration]--macaddrs [macaddrs] --frametype [frametype] --report-interval [report-interval]. Then the data collection session can be started in 10 seconds: $ wificsi_cli start−1. The data collection session can be stopped: $ wificsi_cli stop.

### Active Mode: Configuration API

In active mode, the STA can measure CSI for the 802.11a/g/n/ac/ax/be frames transmitted by the associated WiFi AP.

### API Between the Application Processor and WiFi Chip

| Categories | Fields | Description | Format |
|---|---|---|---|
| Configu- | Mode | Mode = 1 (active mode) | 1 byte |
| ration | ChanSpec | A chanspec holds the channel | 2 bytes |
| | | number, band, bandwidth and | |
| | | control sideband information. | |
| | | The format of the chanspec | |
| | | is as follows: | |

| Bits | Description |
|---|---|
| 7-0 | Channel number |
| 9-8 | 1: lower control |
| | sideband |
| | 2: upper control |
| | sideband |
| | 3: no control |
| | sideband |
| 12-10 | 1: 20 MHz |
| | bandwidth |
| | 2: 40 MHz |
| | bandwidth |
| | 3: 80 MHz |
| | bandwidth |
| | 4: 160 MHz |
| | bandwidth |
| | 5: 320 MHz |
| | bandwidth |
| 15-13 | 1: 2 GHz band |
| | 2: 5 GHz band |
| | 3: 6 GHz band |

| | | | |
|---|---|---|---|
| | Core | A bit mask with the ID of the cores | 1 byte |
| | mask | (receiving antennas) to activate | |
| | | capture (e.g. 0x5 = 0b0101 means | |
| | | setting cores 0 and 2) | |
| | Nsmask | A bit mask with spatial stream IDs | 1 byte |
| | | to capture (e.g. 0x7 = 0b0111 means | |
| | | capturing the first 3 spatial streams | |
| | Frame | Specifies the frame types that are | 1 byte |
| | type | desired to be recorded | |
| | MAC | Sets the MAC address of the WiFi | 6 bytes |
| | address | AP to be associated with | |
| | CSI | 1: Legacy CSI (L-LTF) | 1 byte |
| | type | 2: Generation-specific CSI (HT- | |
| | | LTF, VHT-LTF, HE-LTF, EHT- | |
| | | LTF) | |
| | Duration | Sets the duration (in seconds) of the | 2 bytes |
| | | subsequent CSI collection session. If | |
| | | this configuration is not set, the CSI | |
| | | collection will run indefinitely until | |
| | | manual stop. | |
| | Request | Sets the interval (in milliseconds) | 2 bytes |
| | interval | the STA requests CSI from the AP | |
| | Report | Sets the interval (in milliseconds) of | 2 bytes |
| | interval | the CSI report from the module | |
| Control | Start -N | Start CSI data collection after N | |
| | | seconds (when N = 0, start CSI | |
| | | collection immediately) | |
| | Stop -M | Stop the CSI collection after M | |
| | | seconds (when M = 0, stop CSI | |
| | | collection immediately) | |

### Reference Test Setup

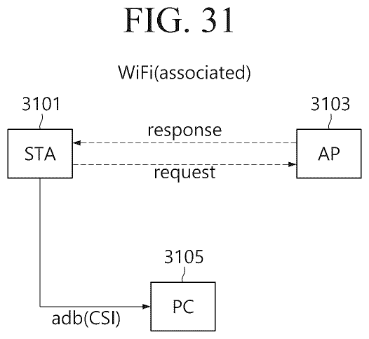

FIG. 31 illustrates a reference test setup in accordance with an embodiment. The test setup may include a station (STA) 3101 and an AP 3103, where the STA transmits a request to the AP and the AP transmits a response to the STA. Information from the STA can be provided to a PC 3105.

On PC 3105, the command line tool first accepts configuration options from user to setup a CSI data collection session: $ wificsi_cli -mode 1--chanspec [chanspec] --coremask [coremask]--nsmask [nsmask] --period [period] --macaddr [macaddr] --frametype [frametype] --request-interval [request-interval] --report-interval [report-interval].

Then the data collection session can be started in 10 seconds: $ wificsi_cli start --10

The data collection session can be stopped: $ wificsi_cli stop

### Data API

During the WiFi CSI collection session, the WiFi chip may continuously send CSI data to the Application Processor in the form of report messages. The format of the report messages is common for both passive mode and active mode and described below

### Fields

The following table describes the fields in each report message:

| | | | Format |
|---|---|---|---|
| Fields | Description | | (suggestion) |
| Timestamp | Timestamp of when the packet is | | 8 bytes |
| | received based on STA's internal | | |
| | clock (in microseconds) | | |
| RSSI_ant_i | RSSI values for i_th receiving | | 1 byte |
| | antenna | | |
| Frame control | Frame type of the packet | | 1 byte |
| Source MAC | Source MAC address of the Wi-Fi | | 6 bytes |
| address | frame that triggered the collect of | | |
| | the CSI contained in this packet | | |
| Sequence | Sequence number of the Wi-Fi | | 2 bytes |
| number | frame that triggered the collect of | | |
| | the CSI contained in this packet | | |
| Receiving | ID of the receiving antenna for this | | 1 byte |
| antenna index | WiFi packet | | |
| Spatial | ID of the spatial stream for this | | 1 byte |
| stream number | WiFi packet | | |
| ChanSpec | A chanspec holds the channel | | 2 bytes |
| | number, band, bandwidth and | | |
| | control sideband information. The | | |
| | format of the chanspec is as follows: | | |
| | Bits | Description | |
| | 7-0 | Channel number | |
| | 9-8 | 1: lower control | |
| | | sideband | |
| | | 2: upper control | |
| | | sideband | |
| | | 3: no control | |
| | | sideband | |
| | 12-10 | 1: 20 MHz | |
| | | bandwidth | |
| | | 2: 40 MHz | |
| | | Bandwidth | |
| | | 3: 80 MHz | |
| | | bandwidth | |
| | | 4: 160 MHz | |
| | | bandwidth | |
| | | 5: 320 MHz | |
| | | bandwidth | |
| | 15-13 | 1: 2 GHz band | |
| | | 2: 5 GHz band | |
| | | 3: 6 GHz band | |

| | | |
|---|---|---|
| Chip ID | Chip Identification (vendor specific) | 2 bytes |
| TSF | Timing synchronization function (in | 4 bytes |
| | microseconds) | |
| AGC | Automatic Gain Control, for each | |
| | receiving antenna (in dB) | |
| CFO | Carrier Frequency Offset [ppm] | Short int |
| CSI type | 1 - Legacy CSI (L-LTF) | 1 byte |
| | 2 - CSI from HT-LTF (802.11n) | |
| | 3 - CSI from VHT-LTF (802.11ac) | |
| | 4 - CSI from HE-LTF (802.11ax) | |
| | 5 -- CSI from EHT-LTF (802.11be) | |
| CSI length | The length of subsequent CSI data | 2 bytes |
| CSI data | Actual CSI data | variable length |

### Advanced Fields

The following table describes the additional fields that can be obtained from each report message:

| Fields | Description |
|---|---|
| BFI | Beam forming Information reported from the |
| | current WiFi chip, or by monitoring the WiFi |
| | channel for BFI messages from other devices |

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for presence detection based on wireless signal analysis, the method comprising:
extracting features from wireless signals transmitted between a plurality of stations (STAs) and at least one access-point (AP) located within an indoor space comprising a plurality of portions, wherein the AP is located in a particular portion of the space and a plurality of STAs are located in different portions in the space such that there are non-line-of-sight (NLOS) signals between the AP and the plurality of STAs as a result of signal obstructions within the space and there is at least one STA in the same portion as the AP to provide a line-of-sign (LOS) signals with the AP;
processing the features using feature analysis to determine NLOS and LOS conditions of the space; and
detecting a location of a user motion within a particular portion of the plurality of portions of the space based on the feature analysis.

2. The method of claim 1, wherein the features are extracted from channel state information, received signal strength (RSS), or timing information of the wireless signals.

3. The method of claim 1, further comprising computing skewness that describes a difference between obstructed and unobstructed wireless signals to detect the location of the user motion.

4. The method of claim 1, further comprising computing variance of distance by round-trip-time (RTT) of the wireless signals to detect the location of the user motion.

5. The method of claim 1, further comprising computing variance of received signal strength indicator (RSSI) of the wireless signals to detect the location of the user motion.

6. The method of claim 1, further comprising computing a median standard deviation (STD) of channel state information (CSI) difference between two antennas to detect the location of the user motion.

7. The method of claim 1, further comprising computing statistical features of received signal strength indicators (RSSIs) of the wireless signals including at least one of variance of RSSI or standard deviation (STD) of RSSI difference to detect the location of the user motion.

8. The method of claim 1, further comprising:
extracting features from signal amplitude and phase difference from the wireless signals; and
reducing the features for motion detection models to detect the location of the user motion.

9. The method of claim 1, further comprising:
monitoring the plurality of portions of the space without motion for a period of time to compute noise backgrounds for the plurality of portions; and
detecting the location of the user motion based on a comparison with the noise background for the plurality of portions.

10. The method of claim 1, further comprising using machine learning to process the features to detect the location of the user motion, using a state machine to decide the real location of the user motion and reduce a false prediction caused by interference of motion in adjacent rooms, or using a motion model trained by a graph neural network to detect the location of the user motion.

11. The method of claim 1, further comprising using features from multiple links between the plurality of STAs and the AP to detect the location of the user motion.

12. A station (STA) in a wireless network, the STA comprising:
a memory;
a processor coupled to the memory, the processor configured to:
extract features from wireless signals transmitted between a plurality of stations (STAs) and at least one access-point (AP) located within an indoor space comprising a plurality of portions, wherein the AP is located in a particular portion of the space and a plurality of STAs are located in different portions in the space such that there are non-line-of-sight (NLOS) wireless signals between the AP and the plurality of STAs as a result of signal obstructions within the space and there is at least one STA in the same portion of the space as the AP to provide line-of-sight (LOS) wireless signals with the AP;
process the features using feature analysis to determine NLOS and LOS conditions of the space; and
detect a location of a user motion within a particular portion of the plurality of portions of the space based on the feature analysis.

13. The STA of claim 12, wherein the features are extracted from channel state information, received signal strength (RSS), or timing information of the wireless signals.

14. The STA of claim 12, wherein the processor is further configured to compute skewness that describes a difference between obstructed and unobstructed wireless signals to detect the location of the user motion.

15. The STA of claim 12, wherein the processor is further configured to compute variance of distance by round-trip-time (RTT) of the wireless signals to detect the location of the user motion.

16. The STA of claim 12, wherein the processor is further configured to compute variance of received signal strength indicator (RSSI) of the wireless signals to detect the location of the user motion.

17. The STA of claim 12, wherein the processor is further configured to compute a median standard deviation (STD) of channel state information (CSI) difference between two antennas to detect the location of the user motion.

18. The STA of claim 12, wherein the processor is further configured to compute statistical features of received signal strength indicators (RSSIs) of the wireless signals including at least one of variance of RSSI or standard deviation (STD) of RSSI difference to detect the location of the user motion.

19. The STA of claim 12, wherein the processor is further configured to:
extract features from signal amplitude and phase difference from the wireless signals; and
reduce the features for motion detection models to detect the location of the user motion.

20. The STA of claim 12, wherein the processor is further configured to:
monitor the plurality of portions of the space without motion for a period of time to compute noise background for the plurality of portions; and
detect the location of the user motion based on a comparison with the noise background for the plurality of portions.
